(19) United States
(12) Patent Application Publication
(10) Pub. No.: US 2005/0060396 A1
(43) Pub. Date: Mar. 17, 2005

(54) Device diagnosis system

(75) Inventor: Isao Hirooka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/662,323

(22) Filed: Sep. 16, 2003

(51) Int. Cl. G06F 15/173

(52) U.S. Cl. 709/223

(57) ABSTRACT

The device diagnosis system according to the present invention is characterized by the following: There are provided devices to which different types of diagnostic software are applied. Diagnostic data on these devices is incorporated into a database server for centralized management. The diagnostic software is executed for device diagnosis according to the diagnostic data of this database server. Consequently, an environment is provided in which the diagnosis of a variety of devices located in different positions in a plant can be controlled and executed systematically.

### BACKGROUND OF THE INVENTION

1. Field of Invention

The present invention primarily relates to a device diagnosis system for systematically controlling and executing the diagnosis of field devices located at different positions in a plant.

2. Description of the Prior Art

FIG. 1 is a functional block diagram illustrating the conventional method of diagnosis for field devices in a process control system having a hierarchical structure. Symbol 1 denotes a host system, which is connected to higher-order network 2. Symbol 3 denotes a field control station (hereinafter referred to as an FCS), which is also connected to higher-order network 2.

Symbol 4 denotes an intra-plant network, which is connected to higher-order FCS 3 and to which field devices to be controlled are connected so that the field devices communicate with FCS 3 and prescribed control is performed. Symbols 5A, 5B and 5C denote field devices from different vendors, where 5A indicates company A's valve, 5B indicates company B's valve and 5C indicates company C's valve.

In such a system configuration as described above, the environment in which valves SA, 5B and 5C are diagnosed differs from vendor to vendor. Specifically, 6A is a PC running company A's diagnostic software, which communicates with valve 5A through intra-plant network 4. 6B is a PC running company B's diagnostic software, which communicates with valve 5B through higher-order network 2, FCS 3 and intra-plant network 4. 6C is a PC running company C's diagnostic software, which communicates with valve 5C by means of communication by direct device access.

There are many types of diagnostic software, including an application that diagnoses devices themselves such as in the case of valves; an application that diagnoses clogging in the pressure lead pipe of a pressure transmitter; an application that constantly equalizes databases between different systems; an application that simultaneously monitors the statuses of two or more devices to watch for failures in the control loop; and an application that constantly monitors databases and, if it discovers a specific event, notifies the user accordingly.

Should any valve which is a field device fail, damage that would be inflicted on a plant would be enormous. It is therefore necessary to predict failure before it actually occurs and perform preventive maintenance. Thus, predictive diagnosis is performed according to the total operating time, the difference between the indicated stroke and actual stroke, and hysteresis.

Conventionally, software for executing these diagnoses has been provided on a vendor-by-vendor basis. In addition, as explained with reference to FIG. 1, these software programs are designed to run under their own environments and there is no such mechanism as to systematically control the programs.

Consequently, the user must not only separately verify diagnostic software programs that are running on two or more PCs but also use different methods of verification. Another drawback is that methods of notification when a failure is actually predicted/detected differ from each other. It has therefore been extremely cumbersome to systematically control these software programs.

### SUMMARY OF THE INVENTION

The present invention has been developed to address these issues and one objective of the invention is to provide an environment whereby it is possible to systematically control and execute diagnosis for a variety of devices located at different positions in a plant.

Another objective of the present invention is to apply a client-server system configuration and provide an environment whereby it is possible to have access to information on device diagnosis being performed from PCs other than the PC that is actually performing the device diagnosis.

### BRIEF DESCRIPTION OF DRAWINGS

FIG. 1 is a functional block diagram illustrating the conventional method of diagnosis for field devices in a process control system having a hierarchical structure.

FIG. 2 is a functional block diagram illustrating the method of diagnosis for field devices in a process control system having a hierarchical structure to which the present invention has been applied.

FIG. 3 is a functional block diagram illustrating the functions of and correlations among elements constituting the main parts of the system according to the present invention.

FIG. 4 is an example of a screen provided by a diagnostic navigator.

FIG. 5 is an example of a screen provided by a diagnostic tool.

### DETAILED DESCRIPTION OF THE PREFERRED EMBODIMENTS

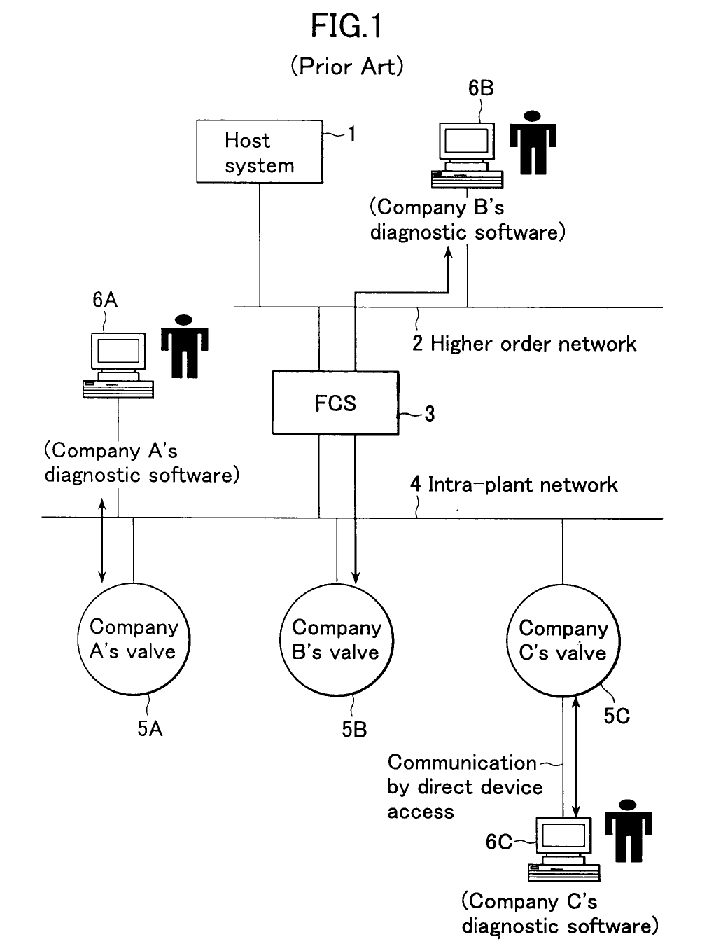

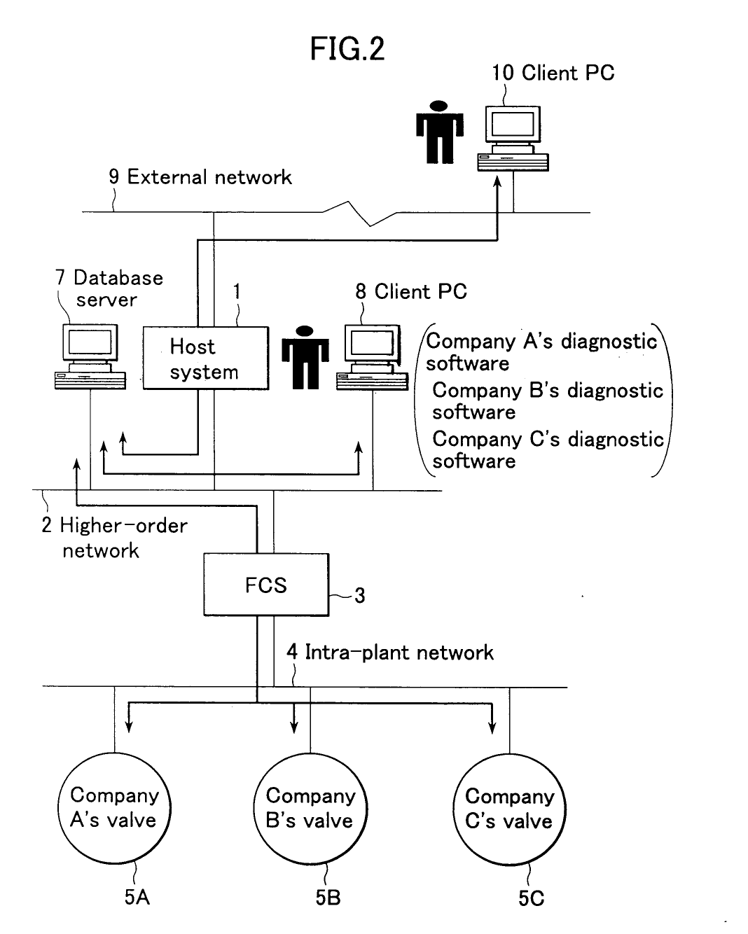

Preferred embodiments are described in detail below by referring to the accompanying drawings. FIG. 2 is a functional block diagram illustrating the method of diagnosis for field devices in a process control system having a hierarchical structure to which the present invention has been applied. Elements identical with those of the conventional system shown in FIG. 1 are referenced alike and excluded from the description.

Symbol 7 denotes a database server, for which data necessary for diagnosing valves is constantly acquired and read from valves 5A. 5B and 5C using the functions of an external tool (not shown in the figure) and saved in the area of “data to be diagnosed.” Alternatively, equipment maintenance personnel or other persons save such data items by manually inputting them.

Symbol 8 denotes a client PC that is a component of a diagnosis execution unit comprising diagnostic software from different vendors. This client PC gains access to “data to be diagnosed” stored in the database server to execute diagnosis under the same environment.

Symbol 9 denotes an external network, such as the Internet, to which host system 1 is connected. Symbol 10 is another client PC connected to this network. The user can have access to the statuses of all diagnostic software running within the same system from any client PC. It is also possible to distribute the execution environments of two or more pieces of diagnostic software to two or more client PCs.

At the client PC functioning as a diagnosis execution unit, a common interface is provided for diagnostic software programs and actions to be taken in case of failure prediction/detection are standardized. Thus, it is possible to send e-mail notifications and issue work requests/instructions to an equipment control system or the like.

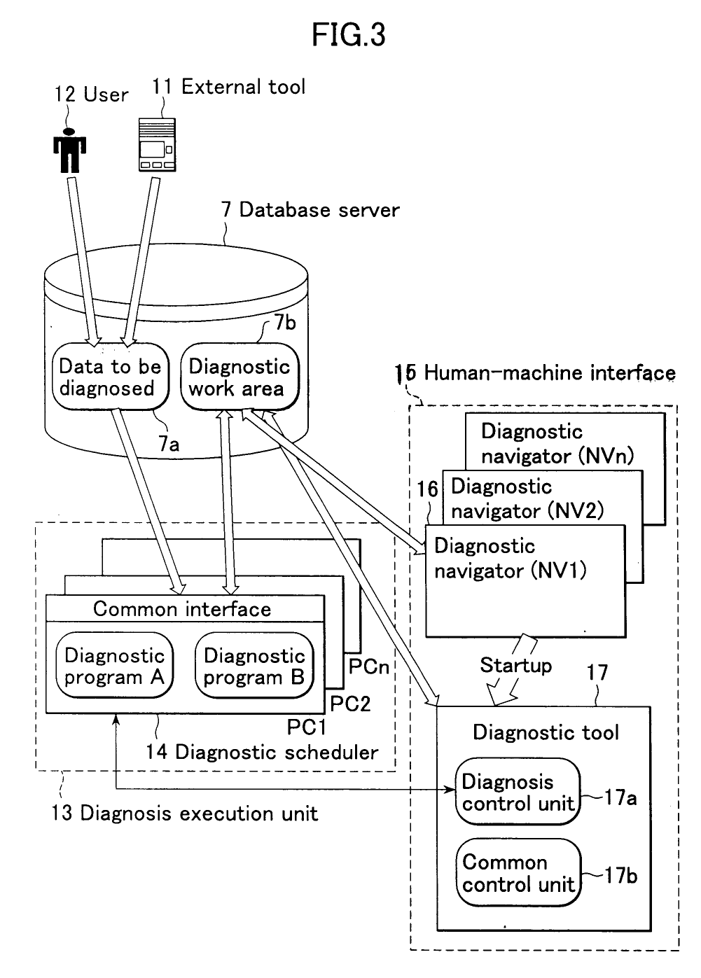

FIG. 3 is a functional block diagram illustrating the functions of and correlations among elements constituting the main parts of the system according to the present invention. In database server 7, symbol 7a denotes an area for retaining data to be diagnosed. The area is being constantly updated with data periodically acquired from external tool 11 and data is manually input by user 12. Symbol 7b denotes a diagnostic work area that contains the data of work performed by all diagnostic software.

The block indicated by 13 and enclosed by a dashed line is a diagnosis execution unit comprising one or more than one client PC (PC1, PC2, . . . , PCn). Each client PC is provided with the functions of diagnostic scheduler 14 comprising one or more than one diagnostic program and a common interface.

This diagnostic scheduler function is a process executed as a Windows “service”. Within this process, each diagnostic software program runs as a thread. Specifically, the diagnostic scheduler provides the following common interface functions and operating environment to diagnostic software.
(1) Loading and unloading diagnostic programs to and from the diagnostic scheduler
(2) Setting the scheduling interval and priority of diagnostic programs
(3) Facilitation of the procedure when a diagnostic program predicts or detects failure
(4) Facilitation of the procedure for storing and obtaining data specific to diagnostic programs in and from a database
(5) Facilitation of the procedure for obtaining data to be diagnosed
(6) Accessing the external tool to specify data to be acquired therefrom
(7) Accessing the external tool to instruct it to start/stop data acquisition
(8) The function for adding/deleting diagnostic programs online to and from the execution environment
(9) The function whereby it is possible to debug/tune diagnostic programs under the execution environment using a general-purpose language (for example, Visual Basic or Visual C++)
(10) The function for collectively browsing and controlling diagnostic software currently running on two or more client PCs

By using this common interface, it is possible for the diagnostic programs to run under a common environment without the need for newly creating diagnostic programs. Making this interface available makes it extremely easy for the user to arbitrarily select diagnostic software and configure a diagnostic system.

In addition, this scheduler function itself has no GUI functions and is controlled from a “diagnostic navigator” or “diagnostic tool” which is discussed later. For the purpose of load distribution this function is designed so that two or more units thereof can run concurrently within the same system.

The block indicated by 15 and enclosed with a dashed line is a human-machine interface and has functions provided by diagnostic navigator 16, as well as those provided by diagnostic tool 17 which is started from this diagnostic navigator. Diagnostic navigators NV1, NV2, . . . , NVn are created according to multiple client PCs (PC1, PC2, . . . , PCn).

Diagnostic navigator 16 is a Windows application for controlling diagnostic scheduler 14 and has the following functions:
(1) Adds/deletes/starts/stops diagnostic software for diagnostic scheduler 14
(2) Verifies the status of each diagnostic software
(3) Permits security control by the user
(4) Starts diagnostic tool 17
(5) Gains simultaneous access to multiple diagnostic schedulers

Diagnostic navigator 16 monitors diagnostic software.

Diagnostic tool 17 executes Windows applications started from diagnostic navigator 16 and provides screens necessary for diagnosis. In addition, diagnostic tool 17 comprises diagnosis control unit 17a for displaying setup screens specific to each diagnostic software, and common control unit 17b for displaying screens common to all diagnostic software.

Common control unit 17b displays screens common to all diagnostic software, wherein the unit provides a screen for setting items related to the scheduling of diagnostic software and for setting actions to be taken if the diagnostic software detects any failures.

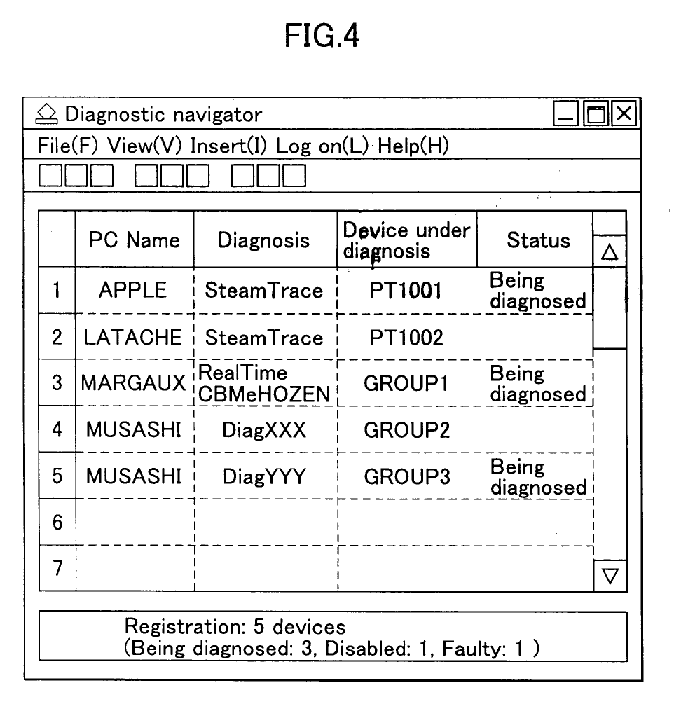

FIG. 4 is an example of a screen provided by diagnostic navigator 16.

This screen indicates the names of five client PCs the names of diagnostic software to be executed, the names of devices under diagnosis, and their operating statuses. Diagnostic software can be selected to start or stop it.

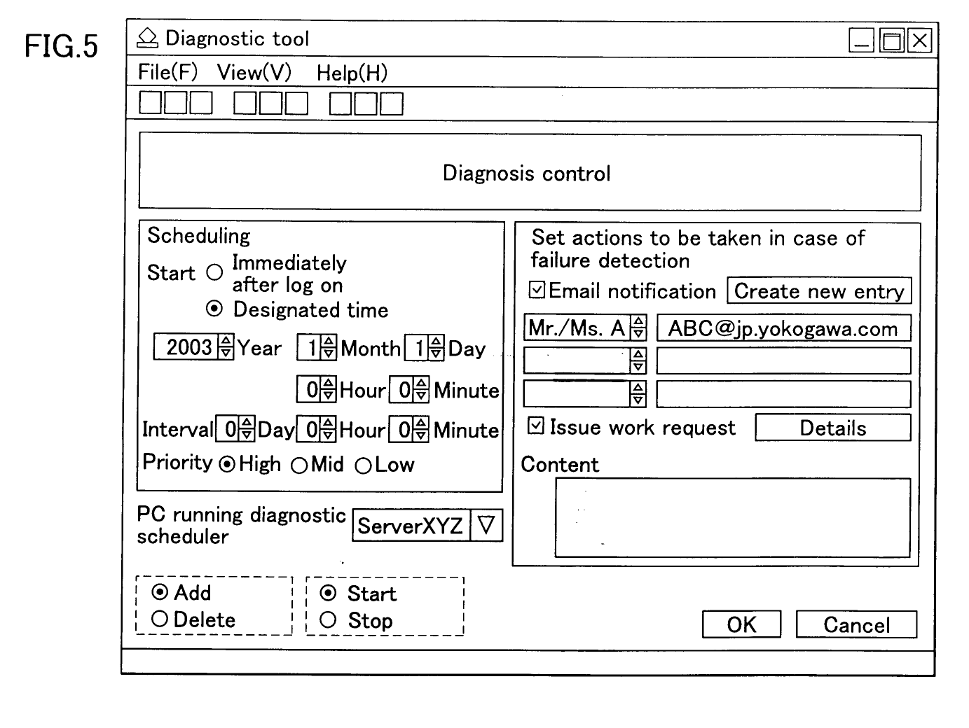

FIG. 5 is an example of a screen provided by diagnostic tool 17. The controls of started diagnostic software are displayed in the upper section of the screen. In the common control area of the lower section, it is possible to set items related to the scheduling of diagnostic software and select the method of notification in case the diagnostic software detects any failures.

According to the present invention all items of diagnostic data are incorporated in the database server for centralized management. Consequently, it is possible for diagnostic software to run on any computer and anywhere in the world by way of the external network, just as it runs on client PC 10 illustrated in FIG. 2, contingent on the software having access to the database.

Since the system of the present invention has a client-server configuration, any client PC that is going to execute device diagnosis can access information on any device diagnosis being currently executed, from any location where the client PC has access to the server. Thus, access to the information can also be made from any PC other than the PC that is actually executing the device diagnosis.

Diagnostic software targeted for use in the present invention is of the type that performs the task of analyzing information (data to be diagnosed) that is stored in a database and of storing these analysis results in the database (diagnostic work area). Devices under diagnosis are not necessarily limited to such hardware components as field devices. Rather, the present invention may be applied to general applications where data needs to be constantly monitored.

In the embodiment illustrated in FIG. 2, an example has been shown in which the execution environment of the diagnostic software and the human-machine interface are integral with the client PC. Alternatively, the execution environment and the human-machine interface may be made separate and independent from each other, so that an environment is provided in which the user performs diagnostic operations on a PC for exclusive use as a human-machine interface.

In the embodiment illustrated in FIG. 3, an example has been shown in which external tool 11 is indicated as the means for acquiring data for incorporation into the database server. Alternatively, by design, the means may be incorporated in the database server as an internal function thereof.

As is evident from the description heretofore provided, according to the present invention, it is possible to easily realize an environment in which the diagnosis of a variety of devices located in different positions in a plant can be controlled and executed systematically.

In addition, by applying a client-server configuration, any client PC that is going to execute device diagnosis can be located in a desired place where the PC has access to the server. Thus, access can be made to information on the device diagnosis being currently executed, from any PC other than the PC that is actually executing the device diagnosis.

1. A device diagnosis system, comprising:
a database server for acquiring and centrally managing diagnostic data on a plurality of devices to which different types of diagnostic software are applied;
a diagnosis execution unit for executing said diagnostic software according to said diagnostic data; and
a human-machine interface for communicating with said database server and said diagnosis execution unit.

2. The device diagnosis system of claim 1, wherein a common interface is provided for the programs of said diagnostic software in said diagnosis execution unit.

3. The device diagnosis system of claim 1 or 2, wherein the work area of said diagnostic software is formed within said database server.

4. The device diagnosis system of claim 1 or 2, wherein said database server acquires diagnostic data from devices under diagnosis through an external tool and by means of direct input by a user.

5. The device diagnosis system of claim 1 or 2, wherein said human-machine interface comprises diagnostic navigators for monitoring said diagnostic software and a diagnostic tool started from any of said diagnostic navigators to provide screens necessary for diagnosis.

6. The device diagnosis system of claim 1 or 2, wherein said diagnostic tool comprises a diagnosis control unit for providing setup screens specific to respective types of said diagnostic software and a common control unit for providing screens common to all types of said diagnostic software.

7. The device diagnosis system of claim 1 or 2, wherein said diagnosis execution unit is connected to an external network.
